(19) United States
(12) Patent Application Publication
(10) Pub. No.: US 2017/0296994 A1
(43) Pub. Date: Oct. 19, 2017

(54) Arrangement for Loading Particles

(71) Applicant: Tubemaster, Inc., Louisville, NY (US)

(72) Inventors: Clifford L Johns, Louisville, KY (US); Stephen W. Brewer, New Albany, IN (US)

(73) Assignee: Tubemaster, Inc., Louisville, KY (US)

(21) Appl. No.: 15/485,883

(22) Filed: Apr. 12, 2017

Related U.S. Application Data
(60) Provisional application No. 62/322,873, filed on Apr. 15, 2016.

(51) Int. Cl. B01J 8/00; B01J 8/06

(52) U.S. Cl. CPC B01J 8/0035; B01J 8/06; B01J 8/003; B01J 8/002; B01J 2208/00752; B01J 2208/06

(57) ABSTRACT

An arrangement for loading particles through an opening using an upwardly-facing, flexible sheet so that, when particles rest on the flexible sheet and the sheet flexes, the flexing of the sheet breaks up bridges formed by the particles.

This application claims priority from U.S. Provisional Application Ser. 62/322,873 filed Apr. 15, 2016.

### BACKGROUND

The present invention relates to an arrangement for loading particles, such as, for example, loading catalyst particles into the vertical reactor tubes of a chemical reactor.

Many chemical reactors are essentially a large shell and tube heat exchanger vessel, with the reaction occurring inside the tubes and a coolant circulating in the vessel outside the tubes. A chemical reactor vessel also can be a simple tank with a single volume of catalyst inside it, or it may be a single large tube. Some chemical reactions occur in furnace or reformer tubes, which may be a part of a system with 10 to 500 or more such tubes. In any of these reactor vessels, catalyst particles (and other types of particles that are not catalyst), may be loaded into the reactor to facilitate the reaction. The particles are replaced periodically.

The reactor tubes may be quite long, housed in a structure several stories tall, and the particles may be transported up several stories to an elevation above the top of the tubes so they may then flow by gravity into the tubes. The particles typically are supplied in 2,000 pound (or larger) “super sacks”, 55 gallon drums, mini drums, metal bins or plastic bags loaded in pallet-mounted cardboard boxes.

The particles are then carefully loaded into each reactor tube (there may be several thousand tubes in a single reactor) to try to uniformly fill each tube. It is desirable to prevent bridging of the particles in the reactor tube, because bridging can create voids or areas within a tube in which there are no particles. Bridging often occurs when the diameter of the tube is less than five times the diameter of the particles.

In some cases, in a shell and tube reactor in which vertical reactor tubes are supported by upper and lower tube sheets, a template is placed over a portion of the upper tube sheet. The template has openings aligned with the tops of the reactor tubes, with the openings in the templates having a smaller diameter than the inside diameter of the cylindrical reactor tubes in order to restrict the flow of particles into the reactor tubes to prevent bridging in the tubes. Particles are dumped on top of the template, and operators then use their gloved hands, paddles, brooms, or rakes to spread the particles back and forth across the template so that particles fall through the holes in the template and into the respective reactor tubes. Moving the particles back and forth breaks up any bridging of the particles above the template, allowing the particles to flow through the holes in the template and into the reactor tubes.

In other instances, loading sleeves are inserted into each reactor tube, with each loading sleeve having a top opening that is smaller than the inside diameter of the cylindrical reactor tube in order to limit the flow of particles to prevent bridging inside the reactor tubes. Again, the particles are dumped on top of the loading sleeves, and the operators push the particles back and forth across the loading sleeves so that the particles fall through the holes in the loading sleeves and into the respective reactor tubes.

Various other loading techniques also are known, such as the method taught in U.S. Pat. No. 3,223,490 “Sacken”, in which a tray with a plurality of downwardly extending loading sleeves is placed directly above the tube sheet, with the loading sleeves extending into respective reactor tubes. The catalyst is poured onto the tray, and then the tray is vibrated up and down vertically, shaking the particles to break up any bridges and allow the particles to fall through the sleeves in the tray and into the reactor tubes. The vibration of the particles causes them to rub against and impact against each other.

Catalyst is a friable material and thus is brittle and readily crumbled. It is desirable to minimize the opportunity for the particles to rub against or impact against each other or otherwise to be abraded or crushed, because such abrasion and crushing damages the particles and creates dust. Raking the particles back and forth across the template or loading sleeves creates substantial abrading of the catalyst particles, creating dust particles which may not only fall into the reactor tubes creating higher pressure drops than desirable, but which also may become airborne, creating a health hazard for personnel inside the reactor vessel. Vibrating a tray full of catalyst as in the '490 Sacken arrangement also causes the particles to be jostled and to rub against and impact against each other, which also produces similar results.

Flowable particulate materials, such as catalyst, are known to bridge. Bridging and flow irregularity, as well as complete flow stoppage, are especially common when the particle size is large relative to the outlet opening (or, in the case of loading catalyst into vertical multi-tubular reactor tubes, relative to the inner diameter of the tubes). Slowly loading the particles tends to allow them to pack more tightly and more uniformly into a tube or a container. Pressure drop testing is used to confirm the overall packing in a given reactor tube and identify ones that fail the owner-dictated specification range. It is desirable to load all of the tubes in a given reactor as quickly as possible so it may be returned to commercial service as quickly as possible. It is also desirable to load the particles uniformly and in a controlled manner so they do not bridge and so they will have minimal variation in packing density and thus minimal variation in pressure-drop compared to the average.

### SUMMARY

The present invention relates to loading arrangements for loading particles. While the description involves loading catalyst particles into chemical reactor tubes, a wide variety of particulate handling and loading is contemplated here. For example, the invention described here could be used to dispense salt on top of bagels and could be used to load a wide variety of particulate materials onto conveyor belts, hoppers, and so forth.

A flexible sheet is located adjacent to an opening through which the particles will flow, and the particles rest on that flexible sheet. At least a portion of the flexible sheet is caused to flex intermittently (intermittently changing the shape of the flexible sheet, such as causing the flexible sheet to bulge). The flexing is sufficient to break up any localized bridging of the particles adjacent to the opening so that some of the particles can flow through the opening. This arrangement uses much less energy than previous loading arrangements, and it accomplishes the loading while minimizing the amount of jostling of the particles.

In one embodiment, the flexible sheet rests on top of or defines a wall of a chamber that is intermittently inflated and deflated to impart a localized motion to adjacent particles so as to break bridges formed by the particles. In another embodiment, a localized projection or finger beneath the flexible sheet moves relative to the sheet to achieve a similar result. The intermittent flexing of at least a portion of the flexible sheet repeatedly breaks up bridging of the particles adjacent to the opening, allowing the particles to flow through the opening.

Some embodiments of the present invention provide for adjusting the rate of loading of the particles. For example, if the loading device is used to load vertical tubes, the rate of loading may be adjusted as the tubes fill, in order to result in more uniform loading of the tubes. The first particles loaded into the downwardly-extending tubes fall all the way to the bottom of the tubes, so those particles have more kinetic energy than the particles that are loaded later, which do not fall as far. A controlled loading may load the particles more slowly at the beginning and then more rapidly as the tube fills up. This provides adequate time for the greater kinetic energy of the first particles to dissipate so that each particle comes to rest in a position in a given tube before being hit with other incoming, high kinetic-energy particles. Some embodiments of the present invention automatically dispense a unit charge of particles in a controlled manner. Certain embodiments of the present invention, using lost-weight calculations from load cell measurements, gradually increase the rate of particle dispensing into a chemical reactor tube all the way to the highest fill level, resulting in a more uniform pressure drop per unit length of reactor tube. This more uniform loading of particles in the reactor tubes results in better conversion of the feed stocks for a given space-velocity of feed stocks passing by and through the reactor tubes.

### BRIEF DESCRIPTION OF THE DRAWINGS

FIG. 1 is a schematic, section view of a shell and tube type of chemical reactor vessel;

FIG. 2 is a plan view of the upper tube sheet of the reactor of FIG. 1;

FIG. 3 is a broken away, schematic section view of a single reactor tube, tube sheet, and particles, showing the particles bridging across the top opening of the reactor tube;

FIG. 4 is a broken away, schematic section view, similar to FIG. 3, but showing a much larger number of catalyst particles bridging across the top opening of the reactor tube, and illustrating catalyst bridging inside a reactor tube;

FIG. 5 is a broken away schematic section view similar to FIG. 4, but with the addition of a surface above the reactor tube which defines an opening into the reactor tube that has a smaller diameter than the diameter of the reactor tube;

FIG. 5A is a broken away schematic section view similar to FIG. 5, but wherein the smaller diameter opening is formed by a flange at the top of a loading sleeve that extends into the reactor tube;

FIG. 6 is a broken away, schematic plan view of a plurality of loading bladders including flexible sheets resting on top of the flanges of a plurality of loading sleeves;

FIG. 7 is a view along line 7-7 of FIG. 6 of the loading bladder with the flexible sheet and the end seals omitted for clarity;

FIG. 8 is a view along line 8-8 of FIG. 6 of the loading bladder with the flexible sheet omitted for clarity;

FIG. 9 is a schematic view similar to FIG. 8 but with the flexible sheet included, showing the flexible sheet in a relaxed position along both chambers of the sheet;

FIG. 10 is a view similar to FIG. 9, with the left chamber pressurized so as to bulge upwardly to push against particles resting on that chamber, while the right chamber is depressurized such that it slightly collapses due to the weight of the particles resting on that chamber or due to a vacuum pulled on that chamber;

FIG. 11 is a view similar to FIG. 10 but with both left and right chambers depressurized such that they both slightly collapse due to the weight of the particles resting on that chamber or due to a vacuum pulled on that chamber;

FIG. 12 is a broken away, section view along line 12-12 of FIG. 6 with the flexible sheets in a relaxed position along all chambers of the catalyst loading bladder, as shown in FIG. 9;

FIG. 13 is a broken away, section view, similar to FIG. 12, but with the flexible sheets on the left chambers of the catalyst loading bladders in a pressurized condition while the right chambers are in a depressurized condition;

FIG. 14 is a broken away, section view, similar to FIG. 13, but with the flexible sheets on both chambers of the leftmost catalyst loading bladder in a depressurized condition while both chambers of the rightmost catalyst loading bladder are in a pressurized condition;

FIG. 15 is a schematic of the piping and instrumentation diagram for providing pressurized air and vacuum to the catalyst loading bladders;

FIG. 16 is a section view (with section lines omitted for clarity) of four catalyst loading bladders, similar to those shown in FIGS. 12-14, installed on top of loading sleeves on top of an upper tube sheet, with a bulk loading tray resting on top of the catalyst loading bladders, and a walking mat which may be placed on top of the tray;

FIG. 17 is a broken-away, plan view of the bulk loading tray of FIG. 16;

FIG. 18 is a perspective view of another embodiment of catalyst loading bladders, similar to those shown in FIG. 6;

FIG. 19 is a side view of another embodiment of a catalyst loading device; which loads a single tube at a time;

FIG. 20 is a plan view of the catalyst loading device of FIG. 19;

FIG. 21 is a side view of the pneumatic mechanism of the catalyst loading device of FIGS. 19 and 20, showing that it could be manufactured as a one-piece molded or 3-D printed part;

FIG. 22 is a side view, similar to that of FIG. 19, showing the catalyst loading device in operation;

FIG. 23 is a schematic showing how several of the catalyst loading devices of FIG. 19 may be daisy-chained together;

FIG. 24 is a side view of two catalyst loading devices of FIG. 19 mounted on a common rack for ease in loading a plurality of reactor tubes;

FIG. 25 is a section view (section lines omitted for clarity) of yet another embodiment of a loading device, similar to the loading device of FIG. 19, but using a movable mechanical projection to intermittently flex the flexible sheet instead of fluid actuation;

FIG. 26 is a top view of the loading device of FIG. 25 (the flexible sheet has been omitted for clarity);

FIG. 27 is a section view along line 27-27 of FIG. 26;

FIG. 28 is a perspective, exploded view of yet another embodiment of a loading device, similar to the loading device of FIG. 19;

FIG. 29 is a plan view of the two-piece flexible diaphragm of the loading device of FIG. 28;

FIG. 30 is a plan view of one of the two pieces of the flexible diaphragm of FIG. 29; and

FIG. 31 is a section view along line 31-31 of FIG. 30.

### DESCRIPTION

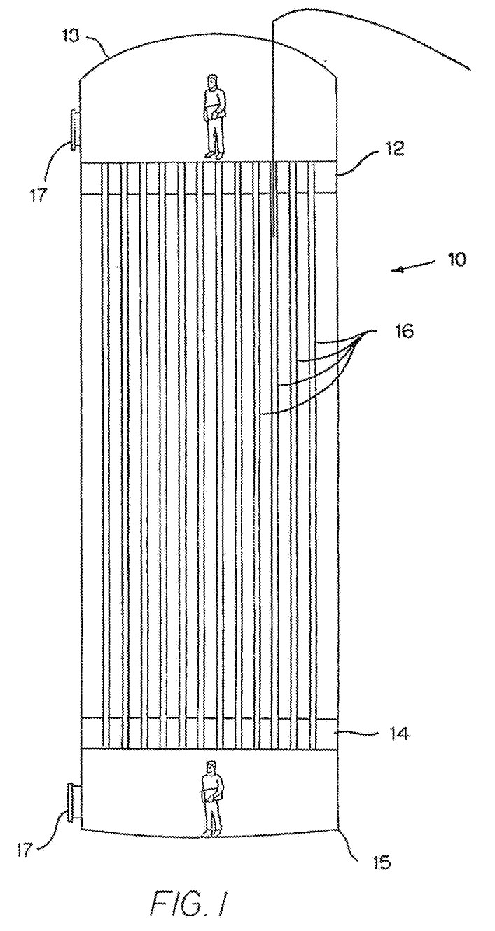

FIG. 1 depicts a typical chemical reactor vessel 10, which is a shell and tube heat exchanger, having an upper tube sheet 12 and a lower tube sheet 14 with a plurality of vertical tubes 16 welded or expanded to the tube sheets 12, 14 to form a tightly packed tube bundle. There may be from one to many hundreds or even thousands of cylindrical tubes 16 extending between the tube sheets 12, 14. Each tube 16 has a top end adjacent the upper tube sheet 12 and a bottom end adjacent the lower tube sheet 14, and the tubes 16 are open at both ends, except that there is a clip or spring at the bottom end to retain catalyst or other particles inside the tube 16. The upper and lower tube sheets 12, 14 have openings that are the size of the outside diameter of the tubes 16, with each tube 16 located in its respective openings in the upper and lower tube sheets 12, 14.

The vessel 10 includes a top dome (or top head) 13 and a bottom dome (or bottom head) 15, as well as manways 17 for access to the tube sheets 12, 14 inside the vessel 10. The manways are closed during operation of the reactor but are opened for access, such as during catalyst handling. In this instance, the reactor tubes 16 are filled with catalyst particles, which facilitate the chemical reaction. (It may be noted that similarly-shaped shell and tube heat exchangers may be used for other purposes, such as for a boiler or other heat exchanger.)

This particular reactor vessel 10 is fairly typical. Its tubes may range in length from 5 feet to 65 feet, and it is surrounded by a structural steel skid or framework (not shown), which includes stairways or elevators for access to the tube sheet levels of the reactor vessel 10 as well as access to intermediate levels and to a topmost level which may be located at or near the level of the top opening of the reactor vessel 10. On a regular basis, which can be every 2 to 48 months or longer, as the catalyst becomes less efficient, less productive, or “poisoned”, it is changed out, with the old catalyst being removed and a new charge of catalyst being installed in the tubes 16 of the reactor vessel 10. Catalyst handling also may have to be done on an emergency basis, on an unplanned and usually undesirable schedule.

A catalyst change operation involves a complete shutdown of the reactor, resulting in considerable cost due to lost production. The loading arrangements shown and described herein may be used both for the initial loading of a new reactor and for catalyst change operations. (They also may be used for other situations in which particles are to be loaded into a tube that extends downwardly from a top opening.) It is desirable to minimize the amount of time required for the catalyst change operation in order to minimize the lost production and accompanying cost caused by the reactor shutdown.

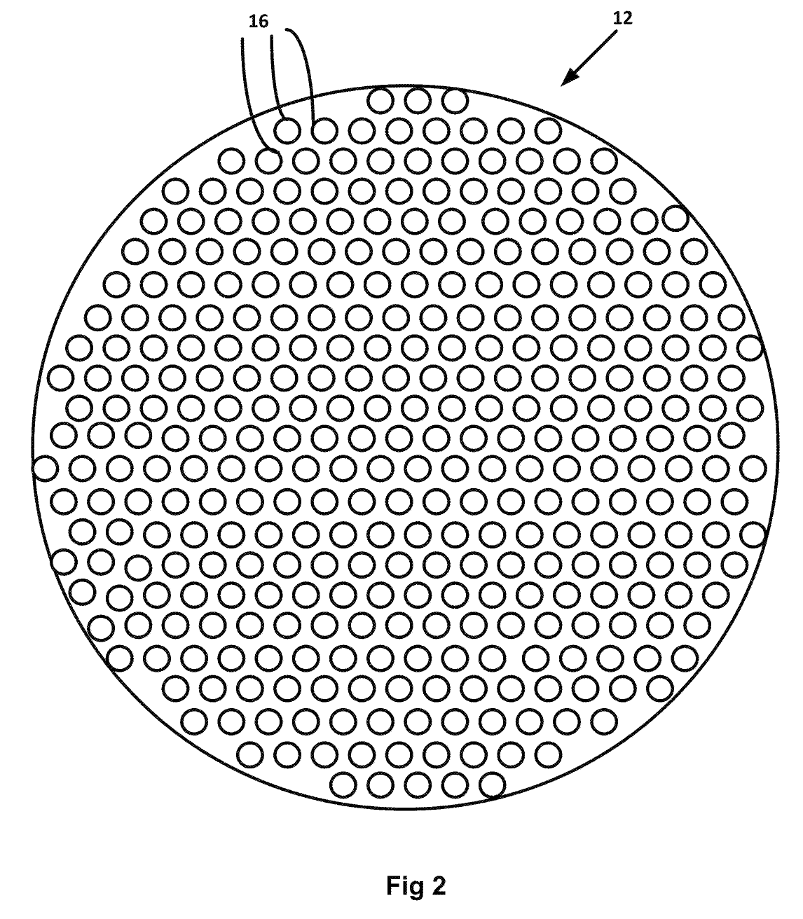

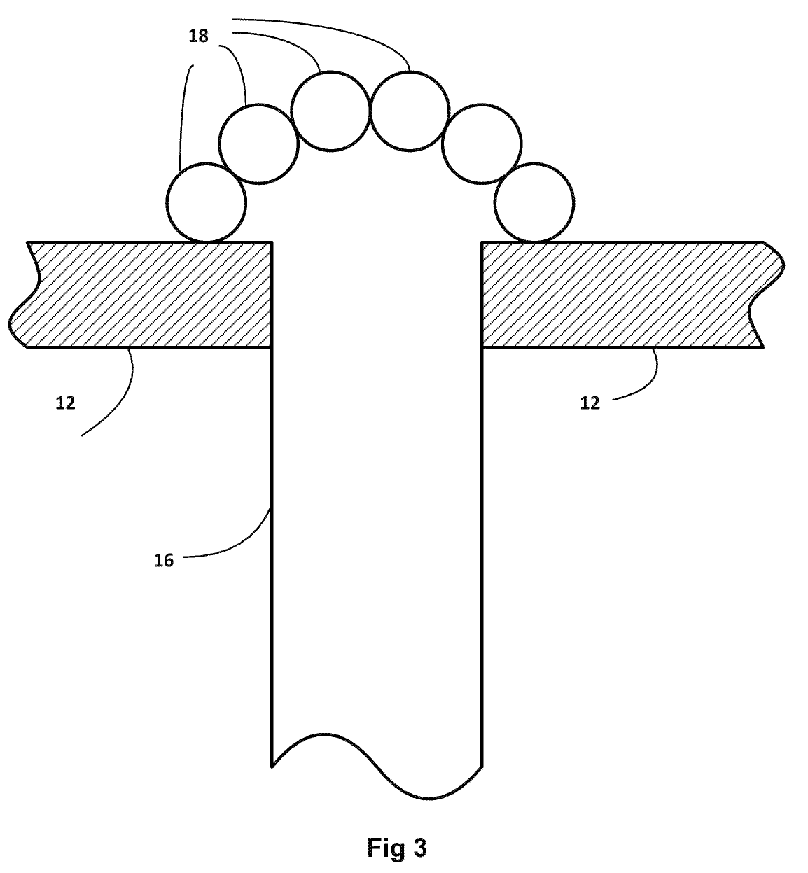

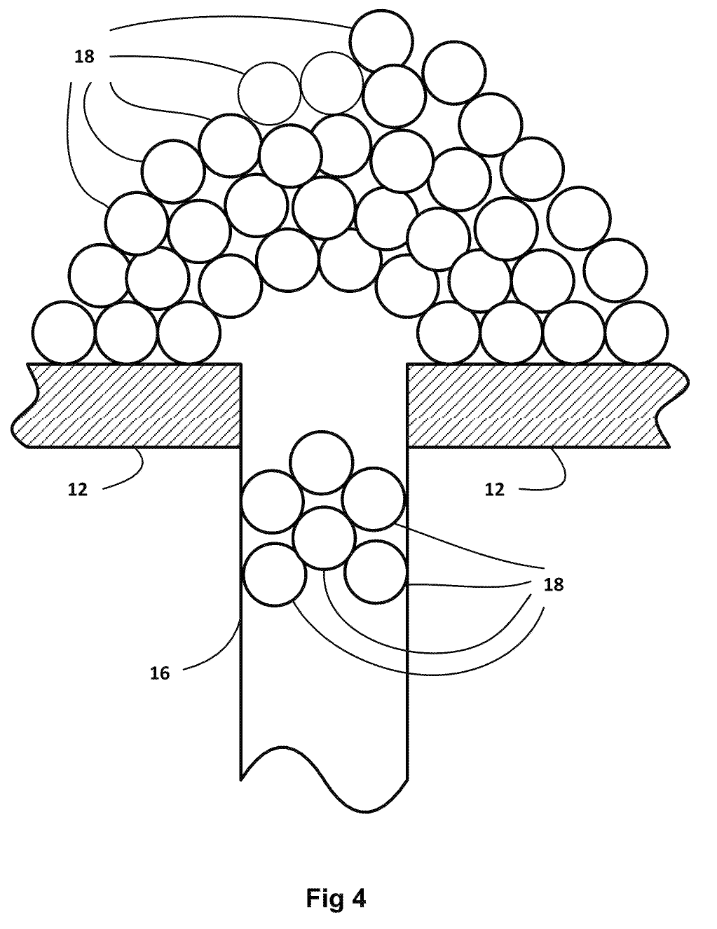

FIG. 2 is a schematic plan view of the upper tube sheet 12 of FIG. 1, including a plurality of reactor tubes 16 (and is identical to the lower tube sheet 14). As shown in FIG. 3, catalyst particles 18 may bridge over the open top end of the reactor tube 16 when trying to load catalyst into the reactor tube 16, which prevents the particles from entering into the reactor tube 16. FIG. 4 shows that the bridging situation is exacerbated as more catalyst particles 18 are dumped on top of the tube sheet 12. Furthermore, if two or more particles 18 fall into the top opening of the reactor tube at approximately the same time, the conditions are favorable for forming a bridge inside the reactor tube 16, as shown in FIG. 4, which creates a void or space below the bridged catalyst inside the tube 16, preventing the catalyst from uniformly and completely filling the reactor tube 16 and resulting in a non-uniform and undesirable catalyst loading of the reactor tube 16.

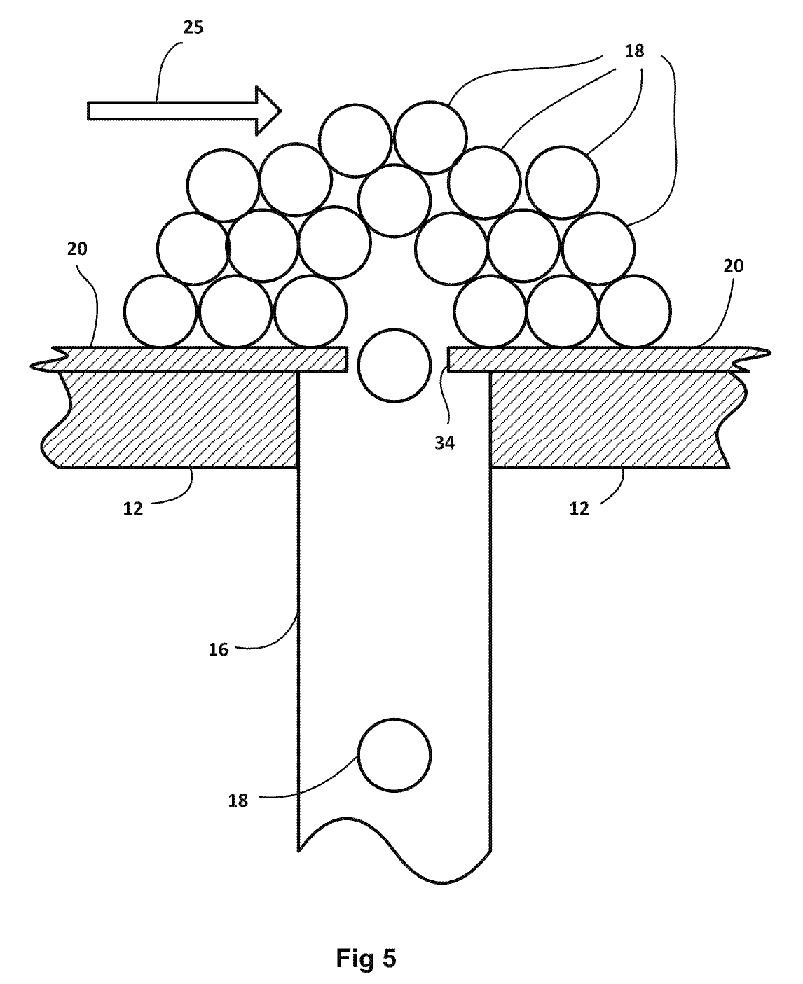

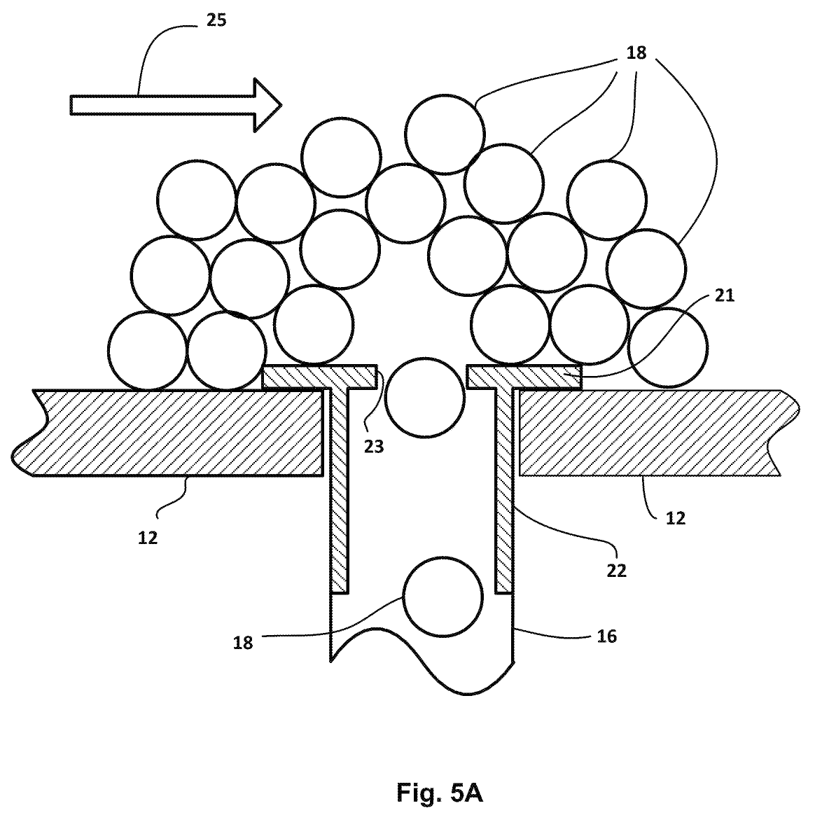

To prevent bridging of catalyst particles 18 inside the reactor tube 16, installers have relied on templates 20 (as shown in FIG. 5) or loading sleeves 22 (as shown in FIG. 5A) which have smaller-diameter openings 34 (in FIG. 5) and 23 (in FIG. 5A) than the inside diameters of the reactor tubes 16 and thereby restrict the flow of particles 18 into the reactor tubes 16 so as to prevent bridging inside the tubes 16. (i.e., if the particles flow through the tube 16 in “single file” or few enough at a time that they cannot span the full diameter of the tube at any one time, bridging will not occur.) However, the catalyst particles 18 still form natural bridges atop the template 20 or atop the loading sleeves 22. In the past, operators have swept the mound of catalyst particles 18, as depicted by the arrow 25 in FIGS. 5 and 5A, using gloved hands, paddles, brooms, rakes, and other such devices to break the bridging so that additional catalyst particles 18 fall through the openings 34 in the template 20 (or through the openings 23 in the flanges 21 of the loading sleeves 22) and drop into the reactor tubes 16. This sweeping action is applied to substantially the entire mass of catalyst particles 18 resting atop the template 20 or loading sleeves 22, causing many of the brittle catalyst particles 18 to fracture and break into smaller particles and forming dust.

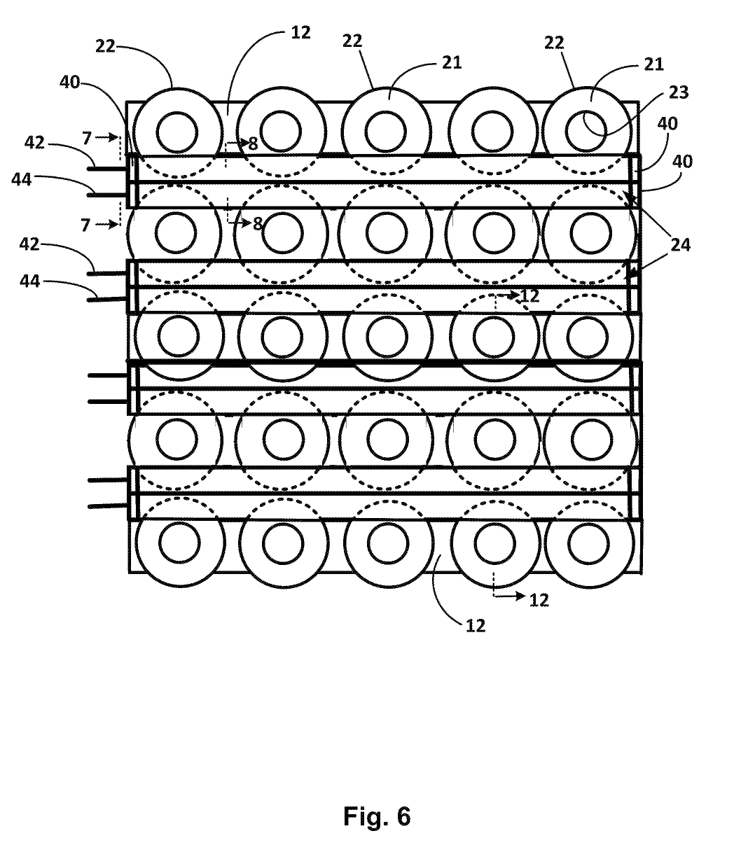

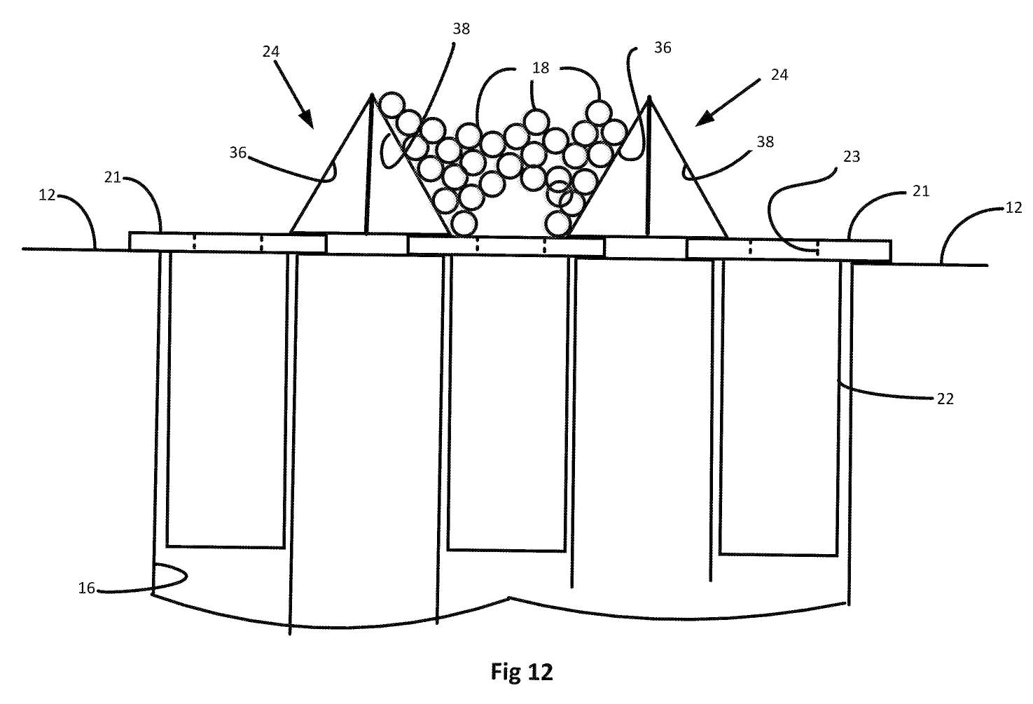

FIGS. 6-14 show an arrangement including a loading bladder 24 for loading particles, such as catalyst particles, into tubes, such as chemical reactor tubes. The loading bladder 24 rests on top of a portion of the flanges 21 of a plurality of loading sleeves 22 (See FIGS. 12-14) (or on top of a portion of a template 20), which rests on top of the upper tube sheet 12 of the reactor 10. In this embodiment, the loading bladders 24 and the flanges 21 with openings 23 function together as a loading arrangement, with particles resting on upwardly-directed surfaces on the flanges 21 and the bladders 24 and then flowing through the openings 23 into the tubes. As may be appreciated in FIGS. 6 and 12-14, each loading bladder 24 lies adjacent to a plurality of openings 23 of the loading sleeves 22, such that some of the particles at the bottom of the pile of particles adjacent to each opening 23 rest on an upwardly-directed surface of a loading bladder 24. In this embodiment, as will be described below, the upwardly-directed surface of the loading bladder 24 tapers downwardly toward the opening 23, to facilitate movement of the particles toward the opening 23, but the taper is not necessary.

The inside diameters of the openings 23 are smaller than the inside diameter of the tubes 16. While, in this embodiment, the openings 23 have a circular shape, the openings 23 could have other shapes, including oval, square, hexagonal, and various irregular shapes, in which case the diameter is considered to be the largest straight line dimension across the opening.

Referring to FIG. 8, the loading bladder 24 has an elongated, rigid structural element 26 with a substantially inverted “T”-shaped profile. In one embodiment, this inverted “T”-shaped structural element 26 is an aluminum extrusion which may be readily cut to the necessary length to accommodate different row lengths on the tube sheet 12. The structural element 26 includes a substantially vertical wall 28 which intersects a substantially horizontal wall 30.

As shown in FIG. 9, an airtight flexible sheet 32 is extended over the structural element 26 to form two independent, longitudinally-directed chambers 36, 38. The chambers 36, 38 may also be referred to as air bladders 36, 38. The flexible sheets 32 may seal against the structural element 26 to form separate chambers 36, 38 by being elastic sheets that are stretched tightly against the structural element 26 or by being adhered or otherwise sealed against the structural element 26, or there may be separate flexible sheets 32 forming the separate chambers 36, 38. The air bladder chambers 36, 38 are sealed at the ends 40 (See FIG. 6), and conduits 42, 44 allow fluid communication into the chambers 36, 38 such that the chambers 36, 38 may be alternately inflated and deflated as desired, as shown in FIGS. 10, 11, 13, and 14.

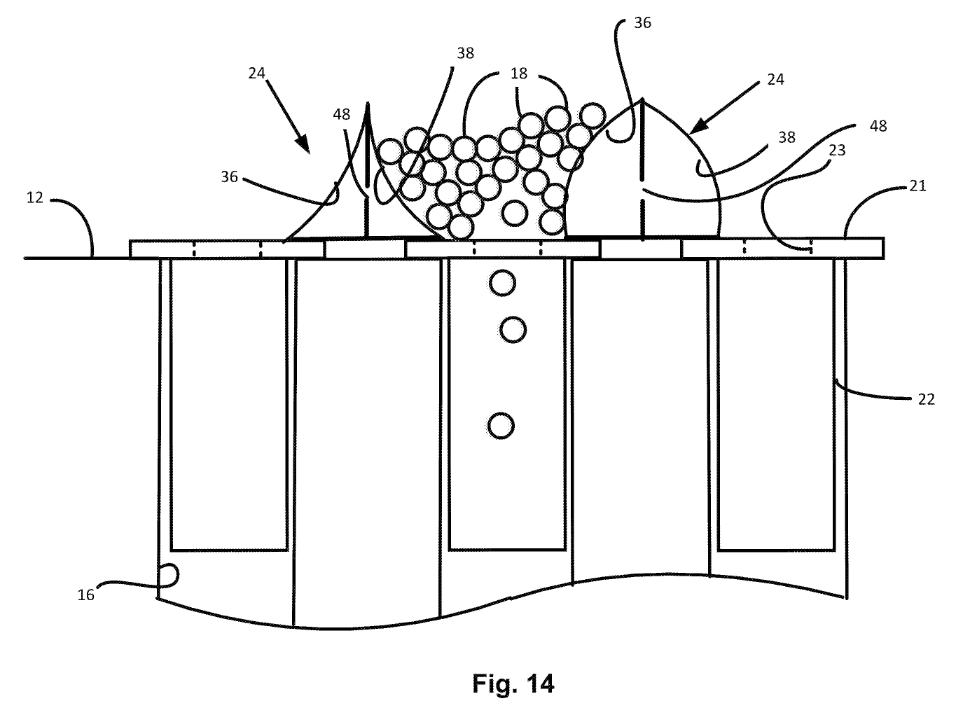

It should be noted that, to facilitate manufacturing and minimize sealing issues, the sheet 32 may be installed as a tubular unit, which is pre-sealed at one end, and which is slid over the structural element 26 in a fashion similar to that of pulling a sock over a foot. It should also be noted that the two chambers 36, 38 need not necessarily be independent of each other. That is, leakage from one chamber to the other may be allowable, especially in the configuration shown in FIG. 14 wherein both of the chambers 36, 38 are either inflated or deflated simultaneously.

In a preferred embodiment, the fluid used to inflate the chambers 36, 38 is a gas, preferably air. Conduits 42, 44 leading to each of the chambers 36, 38 allow the air to be injected to inflate the bladders 36, 38. The same conduits 42, 44 are used to deflate the bladders 36, 38. In some instances, it may be desirable to evacuate the air (that is, create at least a partial vacuum) in the chambers 36, 38 to enhance the expansion and contraction effect of the chambers 36, 38. Other fluids, such as liquids, alternatively could be used to inflate the chambers 36, 38. It should be noted that, while in this embodiment, the flexible sheets on which the particles rest are the same sheets that form the bladders 36, 38, the flexible sheet on which the particles rest could be an independent sheet that rests on top of the bladders 36, 38 and that flexes with the flexing of the bladders 36, 38.

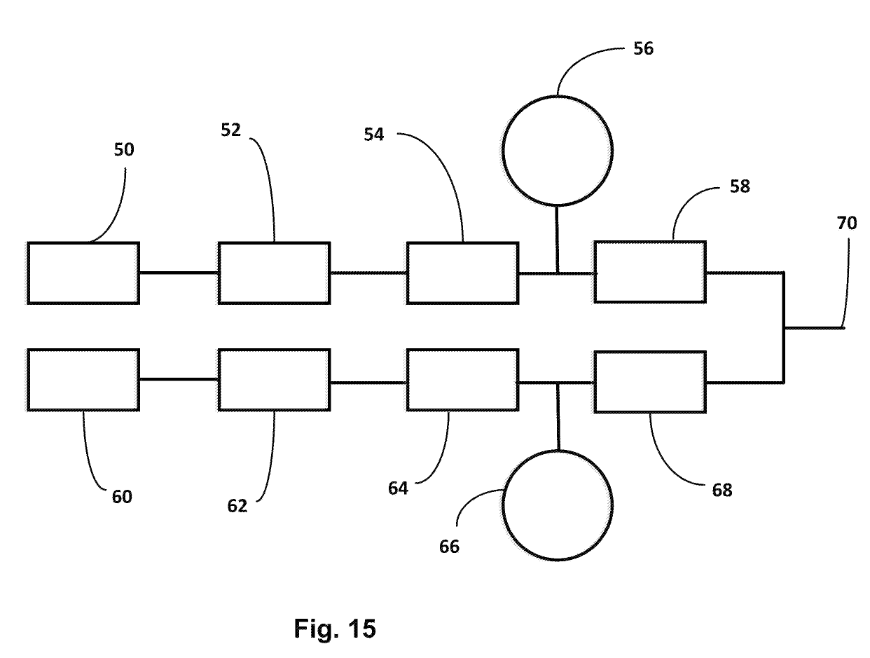

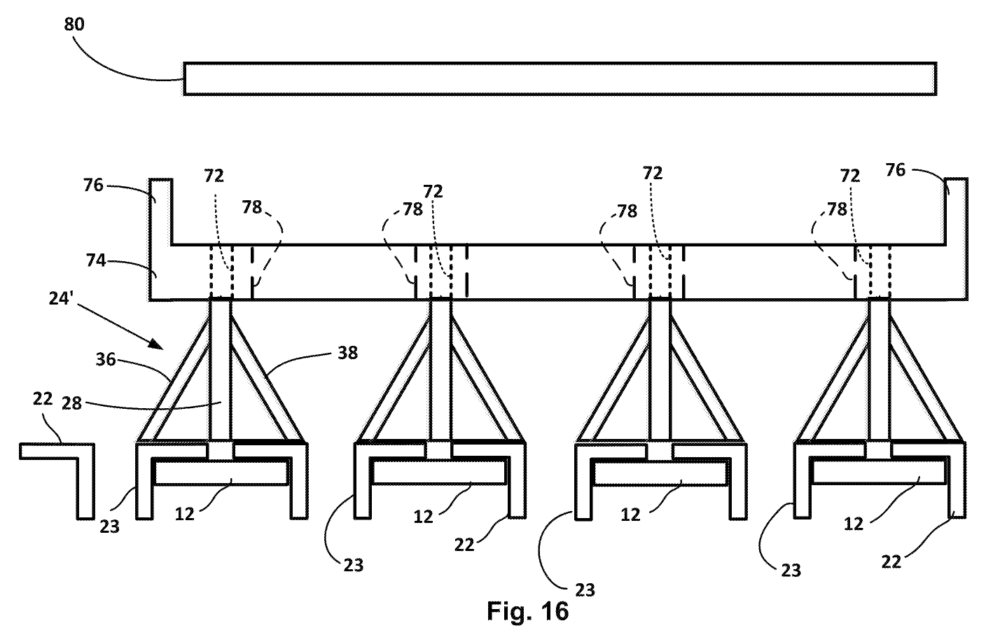

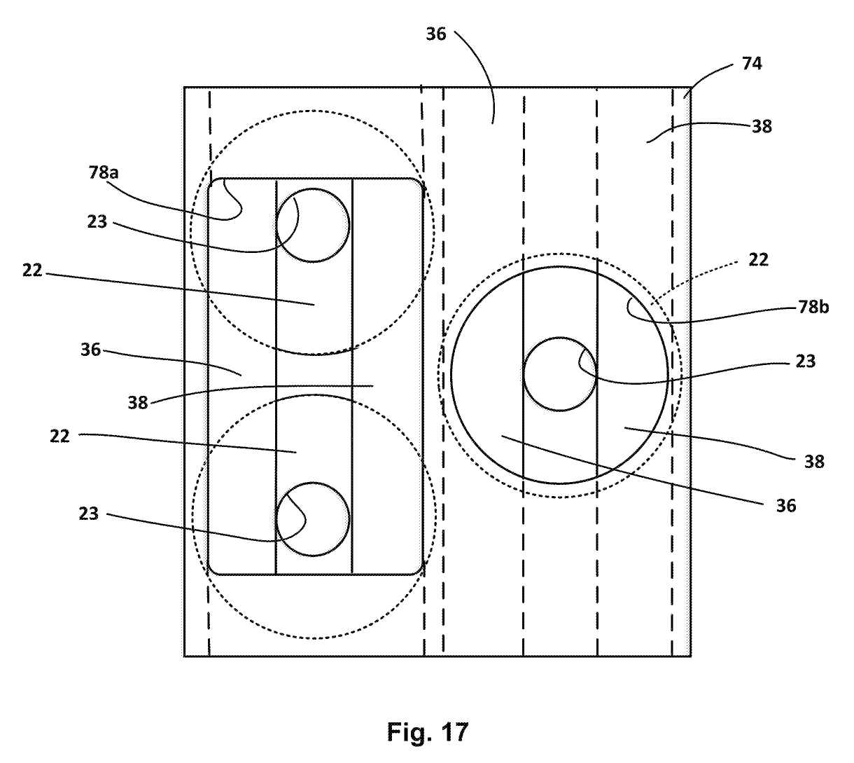

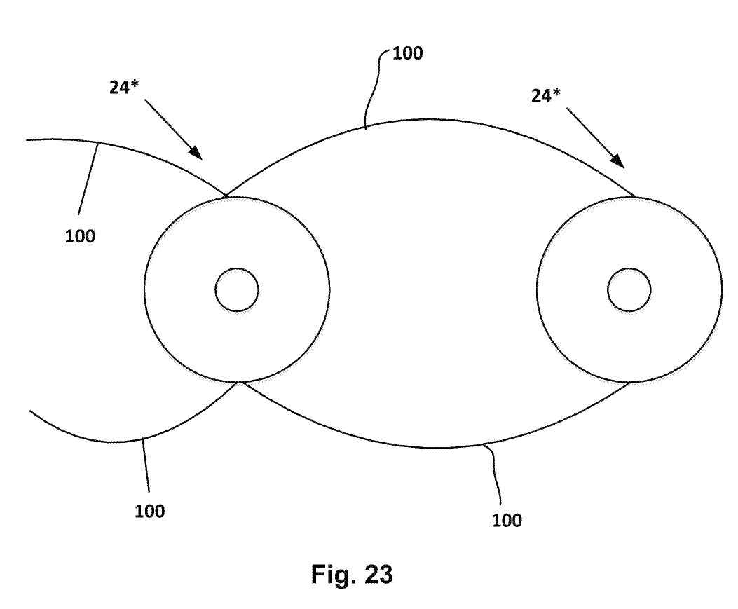

FIG. 15 is a schematic of the piping and instrumentation for the compressed air and vacuum lines which are used with the loading arrangements described above. The lines include a compressed air source 50, a compressed air shut-off valve 52, a compressed air regulator 54, a compressed air pressure gauge 56, and a compressed air solenoid valve 58. The lines also include a vacuum source 60, a vacuum shut-off valve 62, a vacuum regulator 64, a vacuum pressure gauge 66, and a vacuum solenoid valve 68. In this instance, both the compressed air line and the vacuum line are manifolded together into a single outlet port 70 which then connects to one of the conduits 42, 44 of the chambers 36, 38. A similar piping arrangement is attached to the other of the conduits 42, 44 of the chambers 36, 38. A plurality of chambers 36, 38 may be daisy-chained together as shown in FIG. 23 to actuate them with a minimum number of piping arrangements, or each device or small group of devices can be supplied by a header (not shown). It should be noted that it may not be necessary to apply a vacuum to the bladders 36, 38; simply removing the pressurized air by opening a solenoid valve to vent the bladders 36, 38 may suffice to achieve the desired sheet flexion/distortion to break at least one of the bridges which impede the feeding of the particles into the tubes 16.

A controller controls the opening and closing of the solenoid valves 58, 68 for inflating and deflating the bladders 36, 38 to cause the sheets 32 to flex intermittently adjacent to the openings in order to gently move the particles that are in contact with the sheets 32 and to break up bridging of the particles, so the particles flow smoothly through the smaller-diameter openings 23 and into the larger-diameter tubes 16 extending downwardly from the openings 23.

As was discussed earlier, this loading bladder 24 allows for controlled loading of catalyst particles inter vertical reactor tubes 16. Particles loaded in the bottom of the vertical reactor tube 16 have more kinetic energy than those loaded near the top of the tube 16 because they fall a longer distance (in some instances up to 65 feet or more). By controlling the flexing of the sheets 32, this loading bladder 24 controls the rate of flow of the particles.

Each intermittent flexing of a sheet 32 causes a bridge of particles to break up, allowing the particles to flow through the opening 23 until another bridge forms. For a given layout, a test can be run to determine how long it takes for a bridge to form after the sheet 32 has been flexed to break up a previous bridge and how much the sheet must flex in order to break up a bridge. With the information from that test, the amount of flexing and the rate of intermittent flexing of the sheets 32 can be controlled to provide a desired rate of flow of the particles through the openings 23. These parameters may be selected to cause the particles to flow at a slower rate at the beginning, to provide adequate time for the kinetic energy of the first particles to dissipate so that each particle comes to rest at a position in a given tube before being hit by the other high kinetic-energy particles that follow. As the tube fills, the parameters may be adjusted, such as by increasing the rate of intermittent flexing of the sheet 32 to increase the rate of flow of particles into the tubes.

The controller controls the opening and closing of valves to control the amount of fluid that flows into the chambers 36, 38 and the frequency of inflation and deflation of the chambers 36, 38. The amount of fluid that flows into the respective chamber 36, 38 is controlled by controlling the pressure of the pressurized fluid, the size of the valve opening, and the amount of time that the respective solenoid valve is held open to allow the pressurized fluid to enter the respective chamber 36, 38. The amount of fluid is controlled to be sufficient to cause the sheet 32 to flex enough to cause one or more bridges to break. Increasing the frequency of opening and closing the solenoid valves increases the rate of “bridge breaking”, which correlates directly to the rate of feed of the particles through the openings 23 and into the tubes 16. A lower frequency of opening and closing the solenoid valves results in a slower rate of catalyst particle feed and a higher packing density.

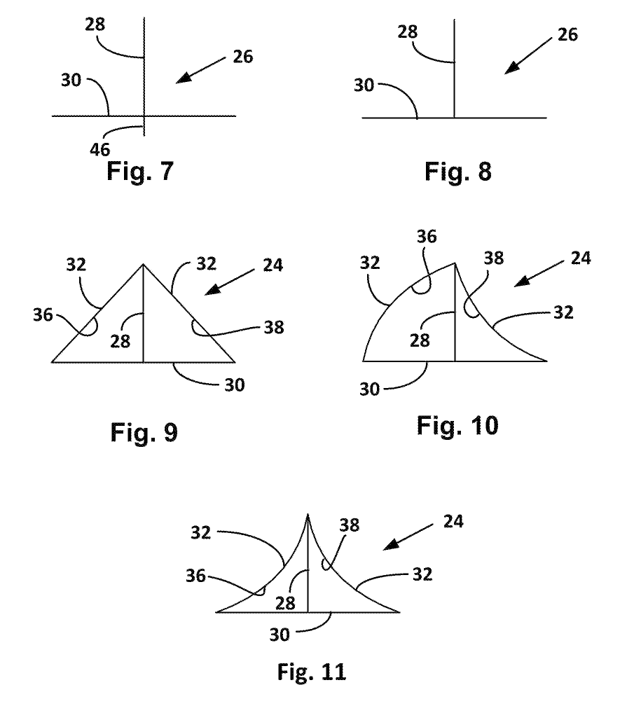

FIG. 7 schematically depicts a short appendage 46 projecting downwardly from the structural element 26. This appendage 46 may be used to releasably secure the loading bladder 24 to the tube sheet 12. In one embodiment, this appendage 46 is a powerful magnet which attracts and secures the loading bladder 24 to the tube sheet 12 (which is generally manufactured from a ferromagnetic material). Another option is for a plurality of the loading bladders 24 to be interlocked (not shown) with their corresponding appendages 46 used to anchor the interlocked loading bladders 24 to one or more available top openings of the tubes 16. Yet another option is to releasably secure the bladders 36, 38 to the flanges 21 of the loading sleeves 22 using a hook and loop type fastener, such as VELCRO®, or a double-sided tape.

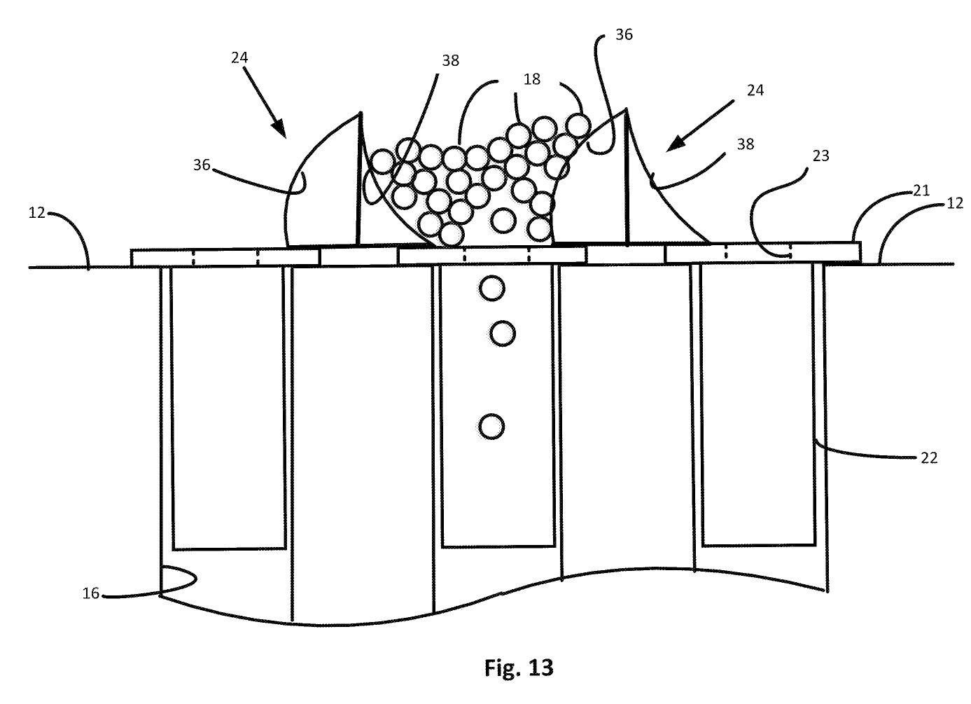

As best appreciated in FIGS. 12-14, the loading bladders 24 are placed on top of the loading sleeves 22 (or on top of the template 20) over the tube sheet 12 such that two adjacent loading bladders 24 lie on opposite sides of a row of openings 23 into tubes 16. Even though only two loading bladders 24 are shown in FIGS. 12-14, one may install as many loading bladders 24 as desired or as required to load a complete reactor 10 or any portion of the reactor 10. The loading bladders 24 are secured to the upper tube sheet 12 as discussed above, and a pressurized fluid source, such as an air compressor, is connected to the conduits 42, 44 of each loading bladder 24, preferably using the piping and instrumentation arrangement shown in FIG. 15. Note that if the chambers 36, 38 will be alternately inflated and deflated within the same loading bladder 24 (as shown in FIG. 13), the conduits 42, 44 are connected to independent fluid sources. However, if the chambers 36, 38 will be simultaneously inflated and then simultaneously deflated within the same loading bladder 24 (as shown in FIG. 14), the conduits 42, 44 may be connected to the same fluid source, or the loading bladder 24 may have a single conduit with an internal port or orifice 48 (See FIG. 14) along the vertical wall 28 to allow fluid communication between the chambers 36, 38. Finally, it should be noted that, to minimize piping considerations, it is possible to hook up all the conduits 42, 44 to the same fluid source, either in parallel or in series, allowing all the chambers 36, 38 to inflate simultaneously and deflate simultaneously. In any case, at least a portion of each sheet 32 intermittently flexes in order to move the particles in contact with that portion of the sheet 32 so as to break up bridges of particles above the opening 23 in order to allow particles to flow into the opening 23.

Once the loading bladders 24 are installed and secured over the loading sleeves 22 atop the upper tube sheet 12 and the corresponding air (or other fluid) lines have been connected, the particles 18 are poured over the loading bladders 24. At least some of the particles 18 adjacent to the openings 23 rest on the sheet 32. The pressurized air is then alternately admitted into some (or all) of the chambers 36, 38 to inflate them momentarily, and then the air is allowed to escape (or is extracted if a degree of vacuum is desired) from the chambers 36, 38 to deflate them momentarily. Each alternating pressurization/depressurization of the chambers 36, 38 breaks up at least one of the bridge of the particles 18, allowing the particles 18 to flow until all the tubes 16 are filled with particles 18.

This flexing of the sheets 32 on which the particles rest imparts a very subtle and very localized motion to adjacent particles 18 so as to break at least one of the bridges formed by the particles. Note that the intent is not to push particles 18 over the opening 23 in the loading sleeve 22 so that the particles 18 will fall in. The intent is to budge the catalyst particles 18 just enough to cause at least some of the bridging to break momentarily. This is enough to allow one or more of the particles 18 directly above (or adjacent to) the opening 23 to break loose and fall through the opening 23. This action is repeated with the alternating pressurization/depressurization of the chambers 36, 38 momentarily breaking the bridging, causing one or more particles 18 to break loose and fall through the opening 23. The force of gravity then shifts at least some of the other particles 18 downwardly, forming a new bridge, and that new bridge is then broken due to the subsequent flexing of the sheets 32, as the chambers 36, 38 are again inflated and deflated, and the cycle is repeated.

If loading sleeves of the type taught in U.S. Pat. No. 7,836,919 Johns et al. are used, it is possible to fully load the tubes 16 all the way up to and including the top of the loading sleeves 22. At that point, the pressurized fluid is shut off to the loading bladders 24 and any excess particles 18 resting atop the upper tube sheet 12 are vacuumed out. The loading bladders 24 are then removed, and the loading sleeves 22 are carefully pulled up and removed (the loading sleeves 22 will be full of particles 18 so they are carefully removed so as not to spill these particles into the tubes 16). The tubes 16 will then be properly loaded with particles to the desired outage level (“outage” is the empty space within the reactor tube above the particles).

FIGS. 16 and 17 depict an additional structure which may be added to the loading bladders 24′ to facilitate loading of the particles onto the loading bladders 24′ and to facilitate walking over the loading bladders 24′ to access other areas of the upper tube sheet 12 (See FIG. 1) without having to remove the loading bladders 24′. In this embodiment, the loading bladders 24′ are substantially identical to the loading bladders 24 described earlier except that the vertical wall 28 extends and projects upwardly, defining a riser 72 which supports a plate 74 above the loading bladders 24′. The edges of the plate 74 define lips 76 to contain the particles (not shown) such that the plate 74 acts as a tray for bulk loading of the particles.

As best appreciated in FIG. 17, the bulk loading tray 74 defines large openings 78a, 78b, which are large enough relative to the size of the particles to allow the particles to fall freely through onto the loading bladders 24′ without bridging on the loading tray 74. The loading bladders 24′ rest on top of the flanges 21 of the loading sleeves 22 on the upper tube sheet 12, adjacent to the small openings 23 of the loading sleeves 22. Two different opening configurations are shown on the loading tray 74—a rectangular opening 78a and a circular opening 78b. Other opening configurations may be used as long as these openings in the loading tray 74 provide relatively unobstructed flow of the catalyst particles from the bulk loading tray 74 onto the loading bladders 24′ and flanges 21 (or templates). These openings 78a, 78b are large enough that there is no possibility of bridging of the catalyst particles to occur in this area.

A second plate 80 may be provided to lie on top of the bulk loading tray 74 (and preferably inside of the lips 76 of the tray 74). This plate 80 may be a metal or wooden plate, or a relative thick rubber mat, which is able to cover over the openings 78 in the bulk loading tray 74, allowing an individual to walk on top of the plate or mat 80 without tripping into the openings 78 of the tray 74. Thus, when the operators need to access an area of the upper tube sheet 12 beyond the area covered by the loading bladders 24′, they can install the plate or mat 80 into the tray 74 (preferably with no catalyst particles remaining in the tray 74), and walk unimpeded over the area.

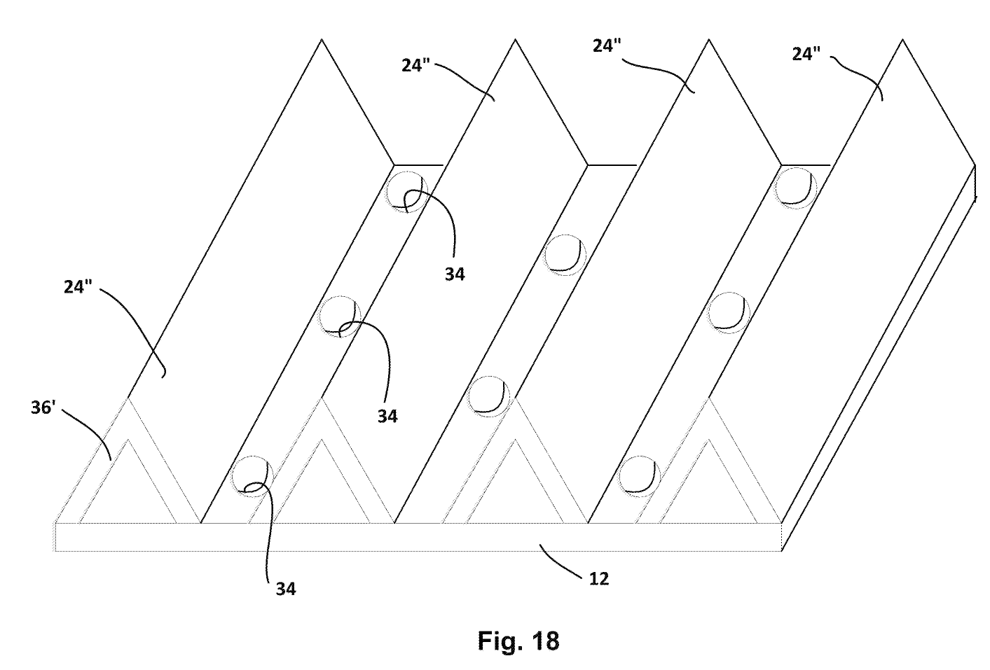

FIG. 18 shows another embodiment of loading bladders 24″, straddling the openings 34 on a template 20. Again, the bladders 24″ together with the template 20 form the loading arrangement. The loading bladders 24″ are sheets that form single, elongated, airtight chambers 36″ (similar to the water-tight bags used as weights to hold down swimming pool covers), with none of the vertical dividers 28 found in the previously described embodiment 24 (See FIGS. 7-11). Thus, the single chambers 36″ inflate when pressurized fluid is admitted to the chambers 36″ and deflate when the pressurized fluid is vented out (or if a vacuum is admitted into the chambers 36″). Adjacent chambers 36″ may be inflated at the same time, or the inflation of adjacent chambers 36″ may alternate to provide the desired bridge breaking. Other than this small difference, the loading bladders 24″ operate in a very similar manner to that of the loading bladders 24 described earlier.

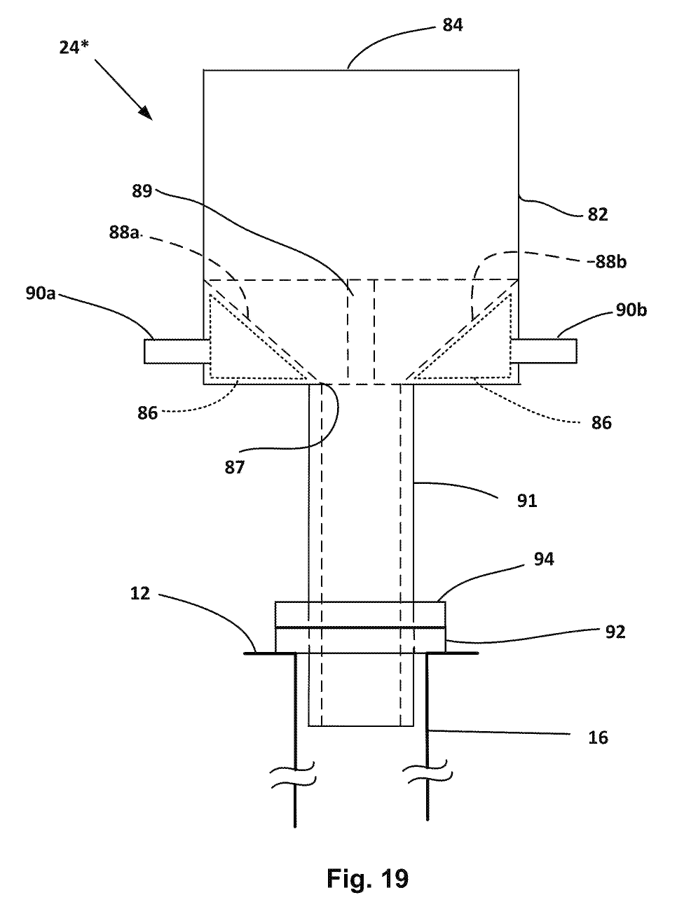

FIGS. 19, through 22 show another embodiment of a loading device 24*. This loading device 24* includes a hopper 82 with an open top 84 for loading particles (not shown) into the hopper 82. A funnel element 86 at the bottom of the hopper 82 has a conical funnel floor (made of sheets 88a, 88b) that tapers downwardly toward the central opening 37 and guides the particles toward the opening 87 through which the particles fall. It should be noted that, while, in this embodiment, the funnel floor is conical, the funnel floor could have other shapes, including bowl-shaped and irregularly-shaped. The particles travel through the outlet tube 91 into the reactor tube 16. As in the previous embodiment, the reactor tube 16 projects downwardly from the opening 87 and has a diameter that is larger than the diameter of the opening 87.

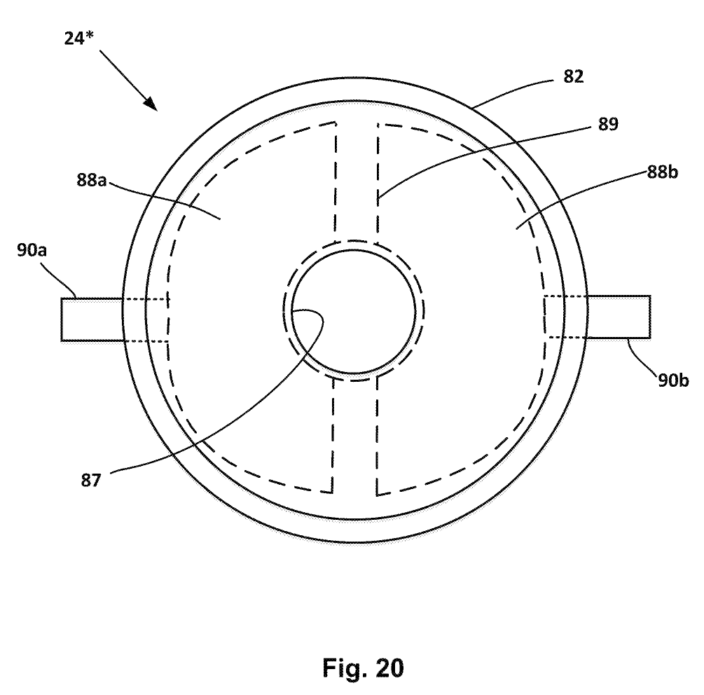

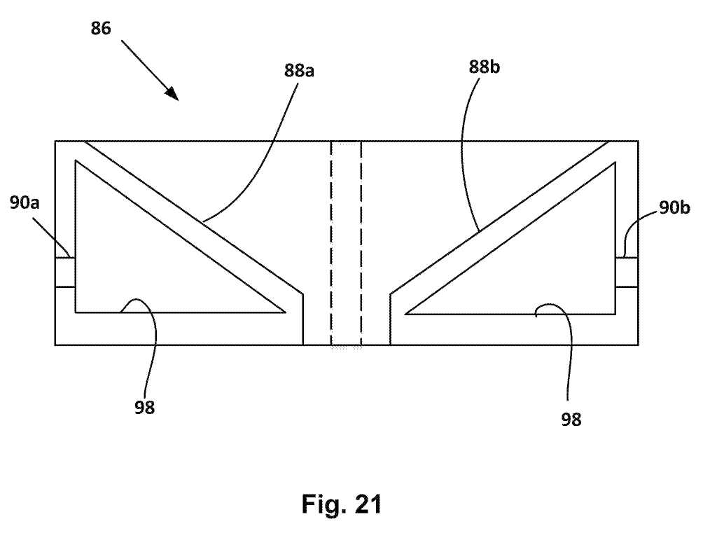

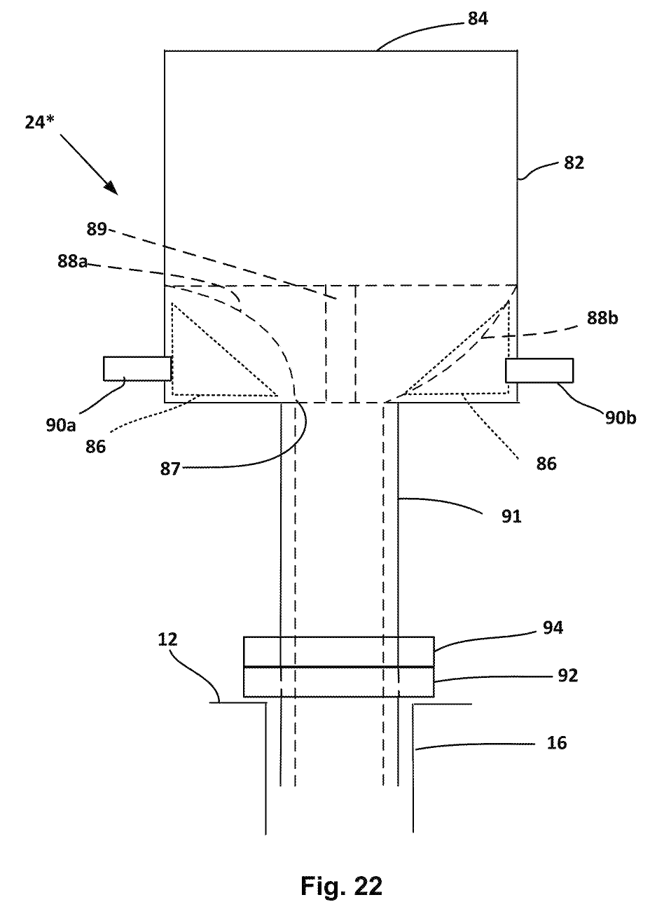

As best appreciated in FIGS. 20 and 22, the floor of the funnel element 86 includes two upwardly-facing, flexible sheets 88a, 88b which are separated by a rib 89 such that there is no fluid communication between the two flexible sheets 88a, 88b. Each flexible sheet 88a, 88b forms the top of a respective chamber, which is in fluid communication with a pressurized fluid source (such as compressed air) via its corresponding port 90a, 90b.

As shown in FIG. 22, the pressurized fluid is introduced to the respective chambers to inflate and deflate the flexible sheets 88a, 88b, causing the sheets 88a, 88b to flex upwardly and downwardly so as to “nudge” at least some of the particles supported on those sheets 88a, 88b far enough to break the bridges that keep the particles from falling through the opening 87 at the bottom of the funnel of the loading device 24*. Of course, as was the case for the previously described loading arrangement 24, the flexible sheets 88a, 88b may be inflated and deflated simultaneously, or they may alternate between being inflated and deflated as shown in FIG. 22.

The piping arrangement shown in FIG. 15 may be used to provide the pressurized fluid to inflate the flexible sheets 88a, 88b as well as to deflate them. As was the case with the catalyst loading bladder 24, the amount of fluid introduced into the respective chamber and the frequency of the inflation/deflation cycle of the flexible sheets 88a, 88b may be controlled in order to increase or decrease the rate at which the particle bridging is broken (and thus the rate at which the particles are fed into the tube 16 through the opening 87).

The loading device 24* may include a load cell 92 mounted under a collar 94 which is affixed to the outlet tube 91 of the loading device 24*. In that case, the loading device 24* is supported by the load cell 92 which rests atop the upper tube sheet 12 of the reactor vessel. A single charge of particles is put into the hopper 82. As the particles flow out of the hopper 82 and into the reactor tube 16, the controller of the catalyst loading device 24* uses the data from the load cell 92 to make lost-weight calculations and controls the inflation and deflation of the sheets 88a, 88b to control the rate of particle dispensing; from a relatively low rate at the beginning (to give the particles adequate time for their kinetic energy to dissipate so that each particle finds a position in a given tube before other high kinetic-energy particles are allowed to come in contact with them), to a progressively higher feed rate as the tube 16 fills to a higher level, with the particles falling a shorter distance and acquiring less kinetic energy. This results in a more uniform loading of particles in the tube 16 and a more uniform pressure drop per unit length of tube 16 which allows, in the case of catalyst, better conversion for a given space-velocity of feed stocks passing through the tubes 16.

FIG. 21 is a side view of the pneumatic mechanism of the catalyst loading device 24* of FIGS. 19 and 20. In this embodiment, the frusto-conical insert 86 is manufactured as a one piece molded or 3-D printed part. The side walls and bottom walls 98 are strong enough to hold their shape (especially since these sides are supported by the walls of the hopper 82, see FIG. 19), while the upwardly-facing floor of the funnel, made of walls 88a, 88b, is a thin enough sheet that it is free to flex as it is inflated by the compressed air admitted into the cavity 98 of the conical element 86 via the corresponding port 90a, 90b.

FIG. 23 is a schematic plan view showing two catalyst loading devices 24* with their pneumatic lines connected in series (a daisy chain arrangement). Each line 100 is connected to a compressed air source and respective solenoid valves (not shown) are controlled so the lines 100 alternately receive pressurized air and then are either vented (to allow the sheets 88a, 88b to deflate naturally) or are connected to a controlled vacuum source to suction down on the sheets 88a, 88b. It will be obvious to those skilled in the art to connect a plurality of the catalyst loading devices 24* in this manner in order to make the best usage of the compressed air source to actuate a large number of the catalyst loading devices 24*.

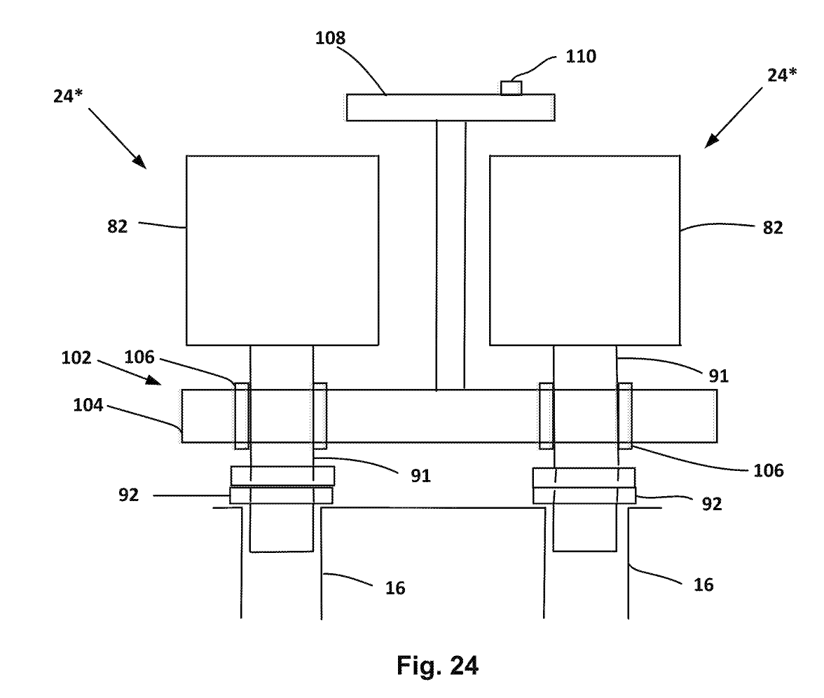

FIG. 24 is a side view of two catalyst loading devices 24* mounted on a common rack 102 for ease of loading a plurality of reactor tubes 16. The rack 102 includes a horizontal member 104. The outlet tubes 91 of the catalyst loading devices 24* are secured, preferably using slidably adjustable clamps 106, to the horizontal member 104. In this manner, the catalyst loading devices 24* can be readily relocated relative to the horizontal member 104 so that the outlet tubes 91 of the catalyst loading devices 24* align properly with the tubes 16 in the reactor.

A “T”-shaped handle 108 is affixed to the horizontal member 104 to enable the user to lift up the entire assembly at once and reposition it in a second set of tubes 16 with a single motion once the first set of tubes 16 has been loaded with particles. The handle 108 includes a start button 110 so that the user can initiate the loading cycle once the loading devices 24* have been inserted into the respective tubes 16. Note that the load cells 92 may be used to indicate to the controller and to the user that the catalyst loading devices 24* have been properly seated inside their corresponding tubes 16 such that it is safe to initiate the loading cycle.

In this embodiment of the catalyst loading devices 24*, it may be desirable to size the hopper 82 (or have a marking in the hopper 82) such that it holds the correct amount of particles needed to load the tube 16 to the desired level.

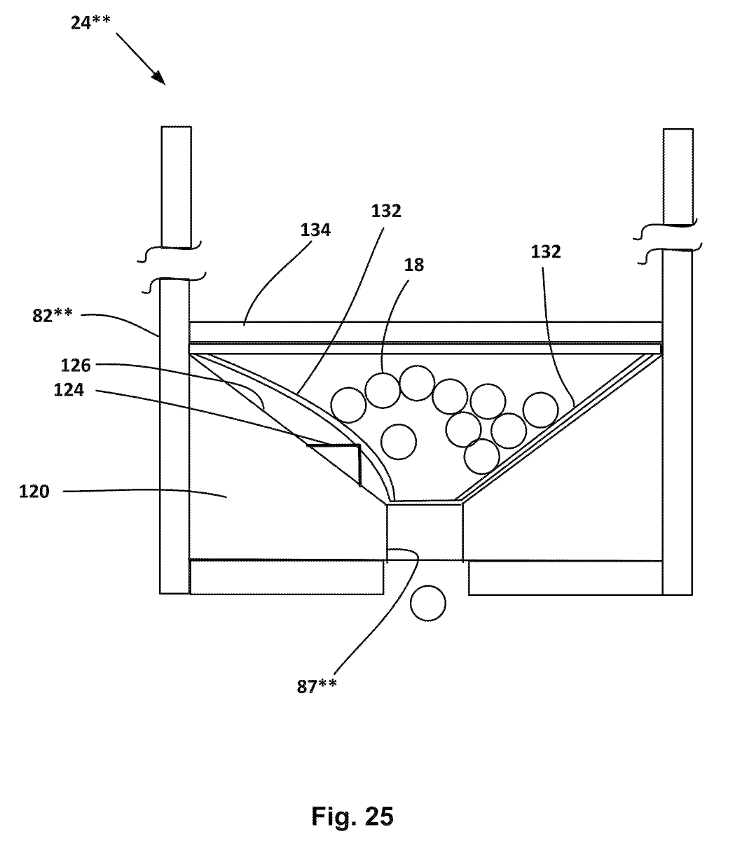

FIGS. 25-27 show a loading device 24** that is very similar to the loading device 24* describe earlier, except that the means for flexing the upwardly-facing, flexible sheet 132 adjacent to the opening 87** is a mechanical means in the form of a moving projection or finger 124 which moves underneath the flexible sheet 132.

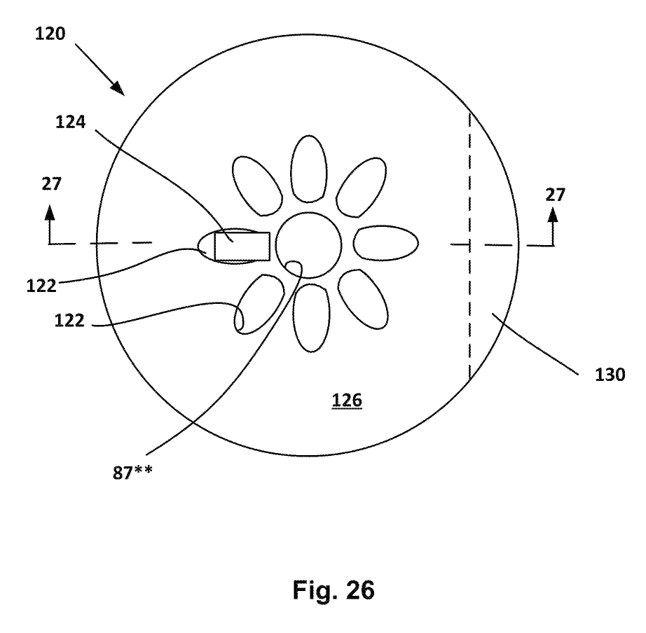

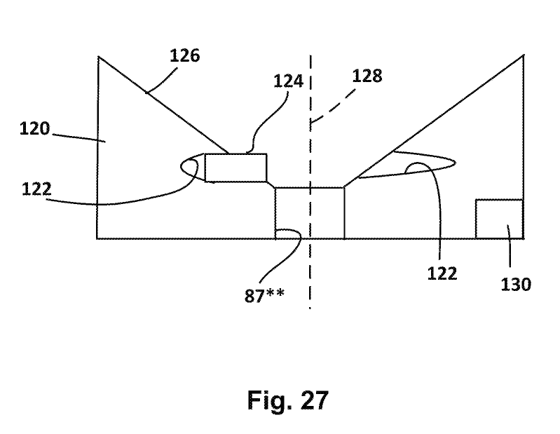

FIG. 26 shows a plan view of the sheet frame portion 120, which provides a generally conical-shaped, rotating floor under the flexible sheet 132. The flexible sheet 132 itself has been omitted for clarity in this view. The frame portion 120 is an inverse frusto-conical solid defining a plurality of horizontally drilled holes 122. At least one of these holes 122 receives a dowel or peg 124, a portion of which projects from the surface of the cone 126, as best appreciated in FIG. 27. Alternatively, the frame portion 120 may just be formed with an upwardly-projecting bump or finger.

The frame portion 120 is a type of turntable and rotates about a vertical axis 128, located at the center of the opening 87**. The rotation can be actuated by any practical mechanism, such as by a rack and pinion gear drive 130 (shown schematically in FIGS. 26 and 27).

As shown in FIG. 25, a flexible sheet 132 is received in, and supported by, the cone 126 of the frame portion 120, and this assembly is housed in the hopper 82** of the catalyst loading device 24**. The flexible sheet 132 is secured to the hopper by an annular ring 134 to ensure that the sheet 132 does not rotate with the frame portion 120. As the frame 120 rotates, the dowel or bump 124 pushes upwardly on the flexible sheet 132 and causes the flexible sheet 132 to flex or bulge upwardly so as to disturb at least one of the particles 18 resting on top of the flexible sheet 132, breaking the bridge and allowing some of the particles to fall through the opening 87** and into the reactor tube 16.

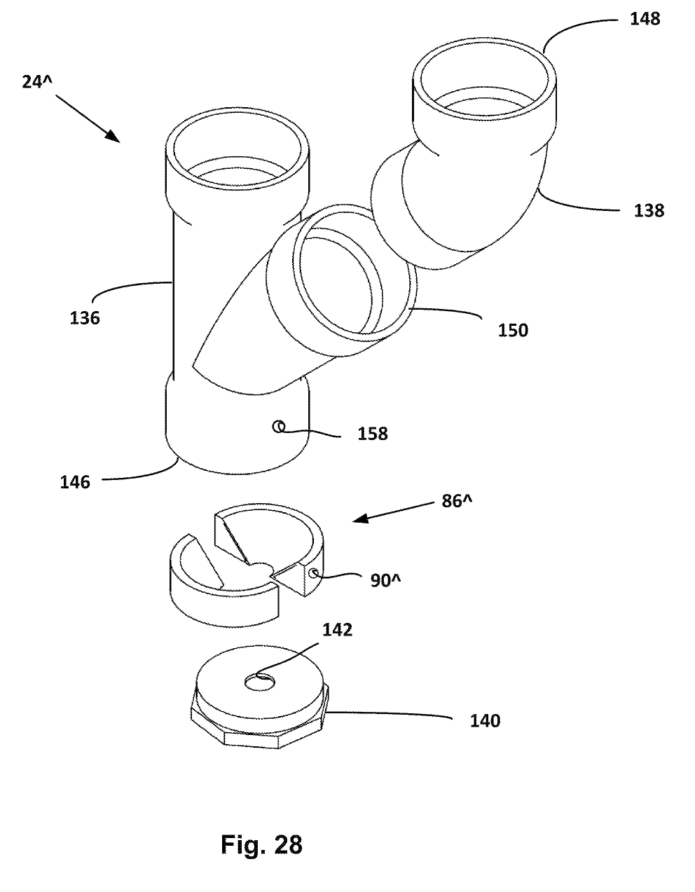

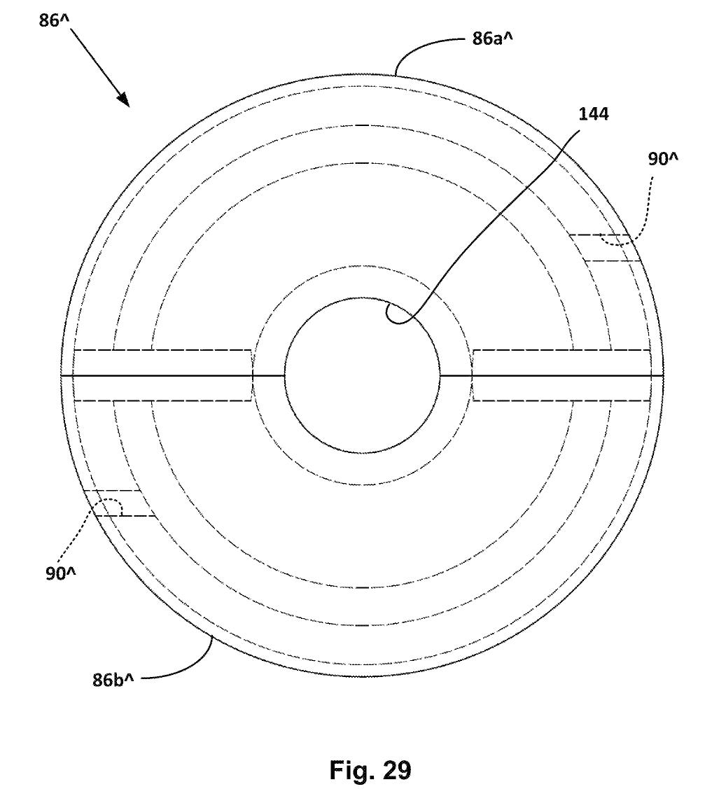

FIGS. 28-31 depict another embodiment of a catalyst loading device 24̂, which includes a two-piece, conical shaped element 86̂ which is quite similar to the conical shaped element 86 of the loading device 24* of FIGS. 19-21. The catalyst loading device 24̂ further includes a PVC “Y” fitting 136, a 45 degree PVC elbow 138, and a PVC end cap fitting 140. The end cap fitting 140 defines a centrally-located through opening 142 which is sized to be at least as large as the opening 144 (See FIG. 29) formed by the two-piece, conical shaped funnel element 86̂. To assemble the catalyst loading device 24̂, the conical shaped funnel element 86̂ is inserted into the bottom end 146 of the “Y” fitting 136, and the end cap 140 is then inserted into this same end 146 so as to “trap” the conical shaped funnel element 86̂ inside the bottom end of the “Y” fitting 136. The end cap 140 may be glued, threaded, or otherwise secured, onto the “Y” fitting 136. The PVC elbow 138 is secured to the skewed end 150 of the “Y” fitting 136.

A length of PVC pipe, not shown, may be added to the top end 148 of the elbow 138 so that catalyst particles may be fed to the catalyst loading device 24̂. In a preferred embodiment, this length of PVC pipe holds a predetermined amount (either by volume or by weight) of catalyst particles so as to fill the reactor tube onto which the catalyst loading device 24̂ is mounted to a desired level. The length of PVC pipe may have a mark, not shown, and catalyst particles are added to the length of PVC pipe up to the indicated mark, and the length of PVC pipe may be preloaded with catalyst particles before it is brought into the reactor or loaded with catalyst particles once it is in the reactor and mounted to the catalyst loading device 24̂.

The main advantages of the length of PVC pipe are that it can be preloaded with a premeasured amount of catalyst particles and the full weight of these catalyst particles is not resting atop the funnel element 86̂. Only those catalyst particles in the vertical portion of the “Y” fitting 136 are resting atop the conical shaped funnel element 86̂. The other particles are supported by the “Y” fitting, the elbow 138, and the PVC pipe itself, with most of the particles being supported by the lower wall portion of the elbow 138.

It should be noted that the particles do not behave as a liquid. The friction between the particles themselves and between the particles and the walls of the “Y” fitting and PVC pipe and elbow prevent the particles from flowing out over the top of the vertical leg of the “Y” fitting. This friction also prevents the weight of all the particles from being supported on top of the funnel element 86̂.

Since the full weight of all the particles is not supported by the funnel element 86̂, less energy is required to break the bridges that form atop the conical shaped funnel element 86̂, and fewer catalyst particles, at any given time, are subjected to the disruptive force exerted by the flexing sheet. This ultimately translates into gentler handling, less breakage, and less dust generation of the friable catalyst particles.

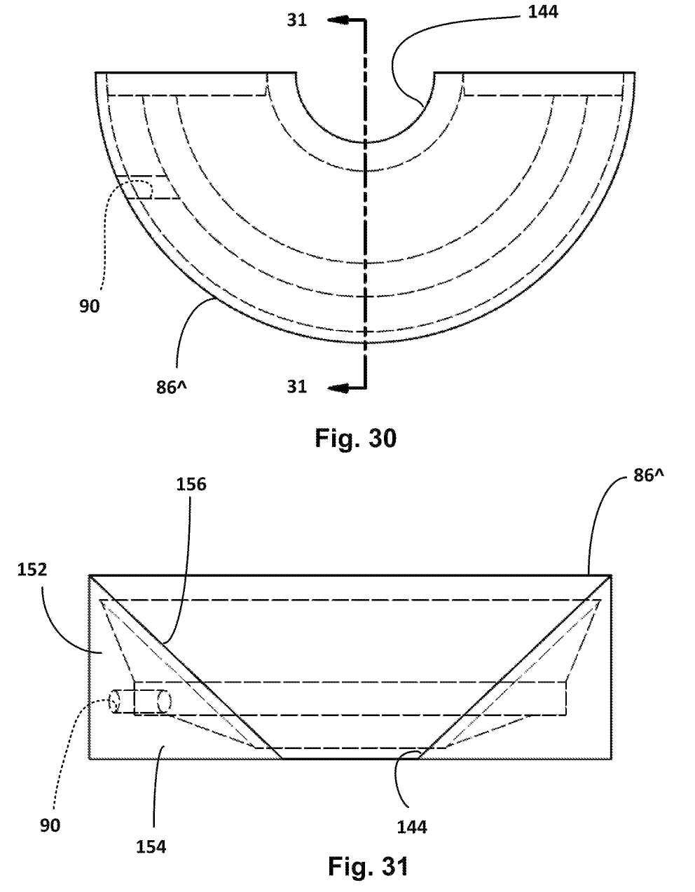

The funnel element 86̂ (See FIG. 29) is very similar to the funnel 86 of FIG. 20, except that the funnel element 86̂ is a two-piece element, comprising two identical elements 86â, 86b̂, and preferably manufactured either by injection molding or 3D printing. As best appreciated in FIGS. 30 and 31, the side and bottom walls 152, 154 respectively of the funnel element 86̂ are substantially thicker than the sloping flexible sheet 156 of the funnel floor, which tapers toward the opening 144. The thicker walls 152, 154 provide more support to prevent the collapse of the funnel element 86̂, while the thinner, sloping, funnel floor sheet 156 allows for added flexibility upon inflation and deflation to break the bridges in particles resting on the funnel floor 156. In this embodiment, the funnel floor sheet 156 has a conical shape.

During assembly, the ports 90̂ (See FIG. 28) of the funnel element 86̂ should be carefully aligned with corresponding openings 158 (See FIG. 28) near the bottom end 146 of the “Y” fitting 136 to allow for the plumbing connection of a fluid for inflation and deflation of the funnel floor sheet 156.

The catalyst loading device 24̂ of FIG. 28 may be used in the same situation and with substantially similar results as the catalyst loading device 24* of FIG. 19.

While the foregoing description relates to the loading of catalyst particles and other particles into the reactor tubes of a vertical tube chemical reactor, the invention also may be used for loading other types of particles This may include arrangements in which the particles pass completely through tubes or in which there are no tubes and the particles fall onto a conveyor belt or other object. It will be obvious to those skilled in the art that modifications may be made to the embodiments described above without departing from the scope of the present invention as claimed.

What is claimed is:

1. An arrangement for loading particles, comprising:
an upwardly-facing surface defining an opening;
at least part of said upwardly-facing surface comprising at least one flexible sheet adjacent to said opening; and
a controller which intermittently flexes at least a portion of said one flexible sheet so as to jostle any particles that may be resting on said portion of said one flexible sheet to allow particles to flow through said opening.

2. An arrangement for loading particles as recited in claim 1, wherein said controller includes a chamber adjacent to said flexible sheet; a source of pressurized fluid; and a valve arrangement that intermittently supplies said pressurized fluid to said chamber to cause said flexible sheet to flex.

3. An arrangement for loading particles as recited in claim 2, wherein said flexible sheet forms a wall of said chamber.

4. An arrangement for loading particles as recited in claim 1, wherein said controller includes a movable projection below said one flexible sheet, wherein moving said movable projection intermittently deflects various portions of said flexible sheet.

5. An arrangement for loading particles as recited in claim 4, wherein said movable projection is mounted on a rotating turntable below said flexible sheet.

6. An arrangement for loading particles as recited in claim 1, wherein said flexible sheet forms at least a portion of a funnel floor.

7. An arrangement for loading particles as recited in claim 2, wherein said flexible sheet forms at least a portion of a funnel floor.

8. An arrangement for loading particles as recited in claim 3, wherein said flexible sheet forms at least a portion of a funnel floor.

9. An arrangement for loading particles as recited in claim 4, wherein said flexible sheet forms at least a portion of a funnel floor.

10. An arrangement for loading particles as recited in claim 5, wherein said flexible sheet forms at least a portion of a funnel floor.

11. An arrangement for loading particles as recited in claim 6, wherein said funnel floor has a conical shape.

12. An arrangement for loading particles as recited in claim 1, and further comprising a vertical, cylindrical tube below said opening, said opening having a first diameter, and said cylindrical tube having a second diameter that is larger than said first diameter.

13. An arrangement for loading particles as recited in claim 2, and further comprising a vertical, cylindrical tube below said opening, said opening having a first diameter, and said cylindrical tube having a second diameter that is larger than said first diameter.

14. An arrangement for loading particles as recited in claim 4, and further comprising a vertical, cylindrical tube below said opening, said opening having a first diameter, and said cylindrical tube having a second diameter that is larger than said first diameter.

15. An arrangement for loading particles as recited in claim 6, and further comprising a vertical, cylindrical tube below said opening, said opening having a first diameter, and said cylindrical tube having a second diameter that is larger than said first diameter.

16. A method for loading particles, comprising the steps of:
providing an upwardly-facing surface defining an opening having a first diameter, at least part of said upwardly-facing surface comprising at least one flexible sheet adjacent to said opening;
placing a plurality of particles on top of said upwardly-facing surface so that at least some of said particles rest on said one flexible sheet; and
intermittently flexing said one flexible sheet to jostle at least some of said particles to break up bridges of said particles and allow said particles to flow through said opening.

17. A method for loading particles as recited in claim 16, wherein said intermittent flexing includes the step of inflating an inflatable bladder.

18. A method for loading particles as recited in claim 16, wherein said intermittent flexing includes the step of moving a projecting finger under said one flexible sheet.
